(19) United States
(12) Patent Application Publication
(10) Pub. No.: US 2026/0111530 A1
(43) Pub. Date: Apr. 23, 2026

(54) Communication with a Data Storage Device with a Web Application

(71) Applicant: Sandisk Technologies, Inc., Milpitas, CA (US)

(72) Inventors: Vishwas Saxena, Ghaziabad (IN); Rashi Gupta, Rampur (IN); Deepankar Kansal, Bathinda (IN)

(73) Assignee: Sandisk Technologies, Inc., Milpitas, CA (US)

(21) Appl. No.: 18/924,819

(22) Filed: Oct. 23, 2024

(51) Int. Cl. G06F 21/44; G06F 13/40

(52) U.S. Cl. CPC G06F 21/44; G06F 13/4027

(57) ABSTRACT

A data storage device includes a storage medium to store user data, a communication interface communicates with a host device, and at least one processor. The processor communicates with the host device over a first communication channel by emulating a network adapter. The first communication channel is enabled by an Ethernet over USB (universal serial bus) protocol driver, such as CDC-NCM (Communication Device Class Network Control Module). The processor also communicates with the host device over a second communication channel that is enabled by a USB mass storage driver. A web application instantiated at a browser of the host device is configured to receive authentication data (such as a password) from a user and the authentication data is communicated from the host device to the data storage device via the first communication channel. In response to verifying the authentication data, selective access to the storage medium is enabled via the second communication channel. The web application can be platform-agnostic.

### TECHNICAL FIELD

The present disclosure relates to communication with a data storage device and a host device. In some examples, the disclosure relates to authentication, access control, and configuration of the data storage device.

### BACKGROUND

Encryption of data enables relatively secure storage on data storage devices, such as block data storage devices connectable via a Universal Serial Bus (USB) cable. However, the user experience is often disappointing because the setup of passwords, keys and the like is cumbersome and complicated for technically unskilled users. If encryption is used, the keys and passwords are too often stored insecurely. As a result, many users leave existing encryption technology effectively unused resulting in exposed confidential data.

In some data storage devices, a physical keypad is provided at the data storage device to enter passwords, keys and the like. In other data storage devices, specialized software or drivers for the data storage device needs to be installed on the host device to enable entry of passwords, keys and the like before secure communication with the data storage device and the host device.

### SUMMARY

There is disclosed a data storage device comprising: a storage medium with at least a secured partition configured to store user data; a communication interface configured to communicate with a host device; and at least one processor. The at least one processor is configured, individually or in combination, to: communicatively couple with the host device, via a first communication channel. The at least one processor is configured to emulate a network adapter to the host device, wherein the first communication channel is enabled by an Ethernet over USB (Universal Serial Bus) protocol driver. The at least one processor is also configured to communicatively couple with the host device, via a second communication channel, wherein the second communication channel enables communication between the storage medium and the host device, and wherein the second communication channel is enabled by a USB mass storage driver. The at least one processor is further configured to receive, via the first communication channel, authentication data from the host device, wherein the authentication data is received from a web application instantiated at a browser of the host device. The at least one processor is configured to: verify that the received authentication data corresponds to a record in an authentication data set; and in response to verifying the received authentication data, selectively enable access between the host device and the secured partition via the second communication channel.

In some examples, of the data storage device, the Ethernet over USB protocol driver is CDC-NCM (Communication Device Class Network Control Model).

In some examples of the data storage device, the storage medium or a further memory is configured to store the web application. The at least one processor is further configured to send to the host device, via the first communication channel, the web application or a representation of the web application.

In further example of the data storage device, the at least one processor is further configured to emulate a server, wherein the server is configured to host the web application.

In some examples of the data storage device, the storage medium further comprises an unsecured partition configured to store the web application, and wherein the data storage device is configured send the web application from the unsecured partition to the host device via the second communication channel. In some examples of the data storage device, the web application stored in the unsecured partition is read-only and/or write protected.

In some examples of the data storage device, the communication interface includes a USB bridge, and wherein the first communication channel and the second communication channel are respective logical pipes through a USB cable between the host device and the data storage device.

In further examples, the data storage device further comprises: a first endpoint set to send and receive data transferred through the first communication channel; and a second endpoint set to send and receive data transferred through the second communication channel.

In some examples the data storage device further comprises a cryptography engine, wherein in response to selective access between the host device and the secured partition. The cryptography engine is configured to: encrypt user data to encrypted data and in response, send the encrypted data to be stored in the secured partition; and decrypt encrypted data stored in the secured partition to user data. The communication interface is configured to receive and send user data between the data storage device and the host device, via the second communication channel.

In some examples of the data storage device, the web application comprises at least one or more of: hypertext markup language (HTML); Cascading Style Sheets (CSS); and JavaScript.

In some examples of the data storage device, the communication interface is configured to transmit and receive data, via the first communication channel, in accordance with Transmission Control Protocol (TCP) and/or User Datagram Protocol (UDP).

There is also disclosed a method for a data storage device to communicate with a host device, the method comprising: communicatively coupling with the host device via a first communication channel, wherein the data storage device emulates a network adapter to the host device. The the first communication channel is enabled by an Ethernet over USB (Universal Serial Bus) protocol driver. The method also includes communicatively coupling with the host device via the second communication channel, wherein the second communication channel enables communication between a storage medium of the data storage device and the host device, and wherein the second communication channel is enabled by a USB mass storage driver. The method also includes receiving, via the first communication channel, authentication data entered into, or via, a web application instantiated at a browser of the host device. The method further includes verifying that the received authentication data corresponds to a record in an authentication data set. In response to verifying the received authentication data, the method includes selectively enabling access between the host device and a secured partition of the storage medium of the data storage device, via the second communication channel.

In some examples of the method, the Ethernet over USB protocol driver uses CDC-NCM (Communication Device Class Network Control Model).

In some examples, in response to receiving a request to access the web application, the method further comprises sending to the host device, via the first communication channel, the web application or a representation of the web application.

In some examples of the method, communicatively coupling with the host device enables access to an unsecured partition of the storage medium of the data storage device. The unsecured partition is configured to store the web application; and the method further comprises: sending the web application from the unsecured partition to the host device, via the second communication channel.

In some example of the method, the web application stored in the unsecured partition of the storage medium of the data storage device is read-only and/or write-protected.

In some examples of the method, the first communication channel and the second communication channel are respective logical pipes through a USB cable between the host device and the data storage device.

In some examples of the method, the secured partition of the storage medium is configured to store encrypted user data, and wherein the method further includes: receiving user data from the host device via the second communication channel and, in response, encrypting, with a cryptography engine, user data to encrypted data; and storing the encrypted user data in the secured partition of the storage medium.

In further examples, the method includes: receiving encrypted user data stored in the secured partition of the storage medium and, in response; decrypting, with the cryptography engine, encrypted user data to user data; and sending user data to the host device via the second communication channel.

In some examples of the method, the web application comprises at least one or more of: hypertext markup language (HTML); Cascading Style Sheets (CSS); and JavaScript.

In some examples of the method, data transmitted via the first communication channel is transmitted in accordance with Transmission Control Protocol (TCP) and/or User Datagram Protocol (UDP).

There is also disclosed a data storage device comprising: means for storing data and means for selectively enabling access between the means for storing data and a host device. The data storage device also comprises means for communicatively coupling with the host device via a first communication channel, wherein the data storage device further comprises means for emulating a network adapter to the host device, wherein the first communication channel is enabled by an Ethernet over USB (Universal Serial Bus) protocol driver. The data storage device also includes means for communicatively coupling with the host device via the second communication channel, wherein the second communication channel enables communication between the means for storing and the host device, and wherein the second communication channel is enabled by a USB mass storage driver. The data storage device also includes means for receiving, via the first communication channel, authentication data entered into, or via, a web application instantiated at a browser of the host device. The data storage device further includes means for verifying that the received authentication data corresponds to a record in an authentication data set. In response to verifying the received authentication data, the means for selectively enabling access is configured to enable access between the host device and the means for storing data, via the second communication channel.

### BRIEF DESCRIPTION OF DRAWINGS

FIG. 1 illustrates a schematic diagram of a data storage device and host device in communication via a first communication channel and a second communication channel with respective drivers;

FIG. 2 illustrates another schematic diagram of the data storage device and host device and components therein;

FIG. 3 illustrates a flow diagram of a method for the data storage device to communicate with the host device;

FIG. 4 is a representation of the host device connected to a network adapter and a mass storage device;

FIG. 5 illustrates a user interface of a host device showing connected networks including to an emulated network via the network adapter;

FIG. 6 illustrates the user interface of the host device showing a connected mass storage device;

FIG. 7 illustrates a representation of a web application at a browser of the host device including a graphical user interface to unlock the data storage device;

FIGS. 8(a) and 8(b) illustrate a representation of the web application at the browser including a graphical user interface to lock the data storage device;

FIGS. 9(a) and 9(b) illustrate a representation of the web application at the browser including a graphical user interface to set authentication data in the form of a password;

FIGS. 10(a) and 10(b) illustrate a representation of the web application at the browser including a graphical user interface to reset the authentication data;

FIGS. 11(a) and 11(b) illustrate a representation of the web application at the browser including a graphical user interface to remove authentication data; and

FIG. 12 illustrates a flow diagram of the data storage device operating to encrypt data received from the host device and to decrypt encrypted data to be sent to the host device.

### DESCRIPTION OF EMBODIMENTS

### Overview

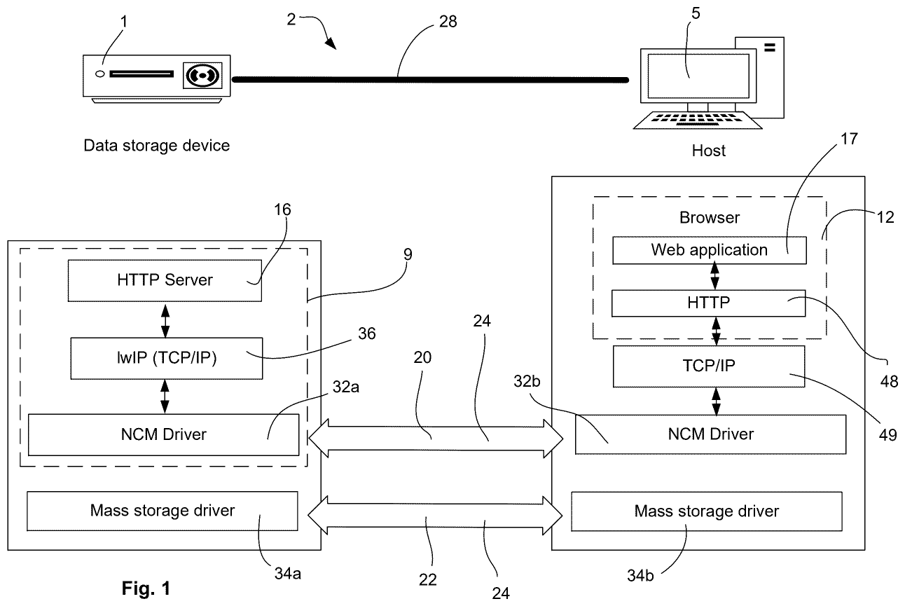

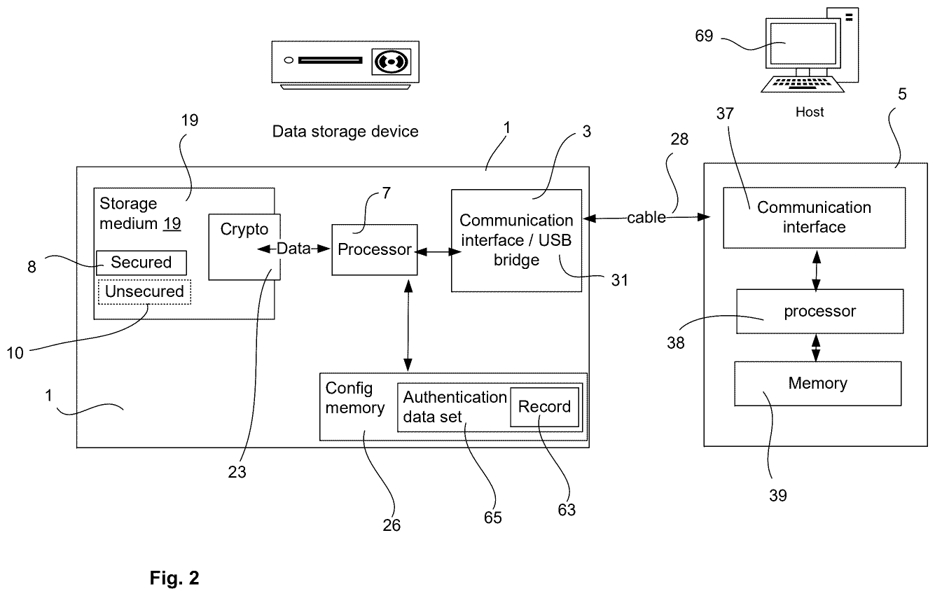

FIGS. 1 and 2 illustrate an example of a data storage device 1 configured to be communicatively coupled with a host device 5. FIG. 1 illustrates a simplified schematic of data flow and technology topology, and FIG. 2 illustrates a simplified schematic of components of the device. The data storage device 1 includes a storage medium 19 with at least a secured partition 8 that is configured to store user data. The data storage device also includes a communication interface 3 configured to communicate with the host device 5, which in some examples includes a universal serial bus (USB) bridge configured to transmit and receive data via a USB cable 28 to the host device 5. The data storage device also comprises at least one processor 7 configured to execute program code stored within a memory 26 to issue commands for controlling the operation of the data storage device 1.

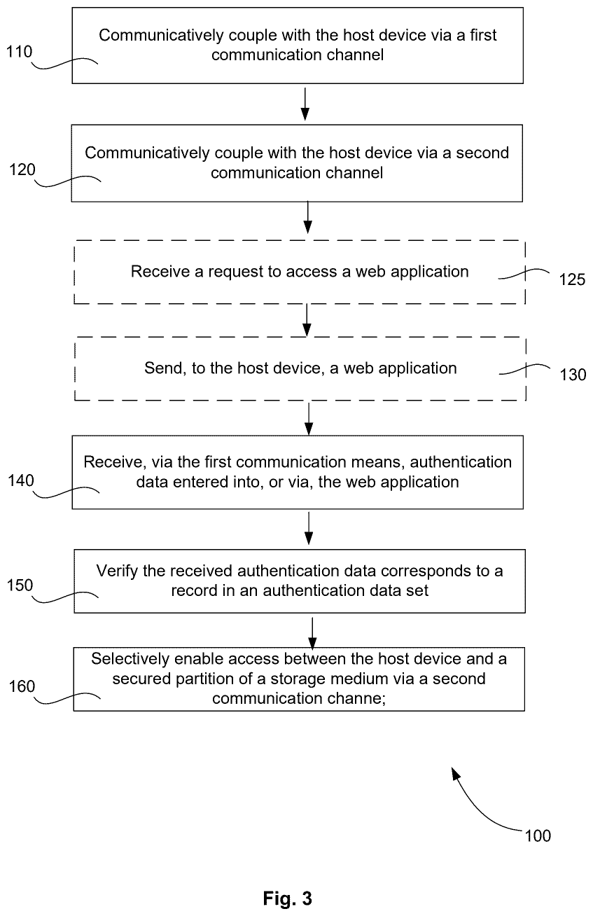

The at least one processor 7 is configured, individually or in combination to perform steps in a method 100, as illustrated in FIG. 3, to enable communication of user data between the storage medium 19 and the host device 5. This includes communicatively coupling 110 with the host device 5 via a first communication channel 20, wherein the at least once processor is configured to emulate a network adapter 9 to the host device 5. The first communication channel is enabled by an Ethernet over USB protocol driver 32a, 32b. Thus from the host device perspective, the first communication channel 20 provides a connection to a (emulated) network. This first communication channel 20 may be configured to transmit and receive security commands discussed below.

The at least one processor 7 is also configured to communicatively couple 120 with the host device 5 via a second communication channel 22, wherein the second communication channel 22 enables communication between the storage medium 19 and the host device. The second communication channel 22 is enabled by a USB mass storage driver 34a, 34b). Thus from the host device perspective, the second communication channel 22 provides a connection to a mass storage device. This second communication channel 22 may be configured to transmit and receive user data.

Thus in some examples, the host device 5 communicating with the communication interface 3 have respective endpoints for two USB devices, namely the (emulated) network adapter and a mass storage device.

The data storage device 1 may be configured to enable selective access to the storage medium 19, such as with verification of authentication data in an unlocking process. This can include the at least one processor 7 receiving 140, via the first communication channel 20, authentication data 61 from the host device 5. The authentication data is be received from a web application 17 instantiated at a browser 12 of the host device 5. Notably, the authentication data 61, which may be part of a security command, is transmitted via the first communication channel 20 enabled by the emulated network adapter.

The at least one processor is configured to verify 150 that the received authentication data 61 corresponds to a record 63 in an authentication data set 65. In response to verifying the received authentication data, the at least one processor selectively enables access between the host device 5 and a secured partition 8 of the storage medium 19 via the second communication channel 22. In some examples, this can include enabling a cryptography engine 23 to encrypt and decrypt user data stored in the secured partition 8 of the storage medium 19.

In some examples, the Ethernet over USB protocol driver 32a, 32b, is CDC NCM (Communication Device Class Network Control Model). This can be advantageous in that CDC NCM drivers are provided on a wide variety of operating systems in contemporary host devices 5. This can include Windows and MacOS for laptop and desktop computers, as well as operating systems of mobile devices including some tablet devices and smartphones.

Therefore examples of the data storage device 1 can be used with a host device 5 without requiring special drivers to be installed on the host device 5.

Furthermore, the web application 17 is a web-based application that is instantiated in a web browser 12 of the host device 5. This can include any web browser 12 that can run web applications 10. For example, web applications using hypertext markup language (HTML). Advantageously, many computers and mobile communication devices are configured with a web browser 12 and therefore running a web application 17 can be more convenient than requiring users to install a native application to the host device 5. Thus the data storage device 1 can be used with a wide variety of host devices 5 and operating systems without having to install specialised drivers or software. This can be particularly useful in environments where technical, communication, security, organizational policy, or other reasons prevent or impede a user of a host device 5 from installing device drivers or software on the host device 5.

The components of an example of a data storage device will now be described in detail. It is to be appreciated that alternative examples may include more, or less, features.

### Hardware

### Data Storage Device

The data storage device 1, in general, is configured to be used with a host device 5 to store user data. In some examples, the data storage device 1 is a device external to the host device 5 and can be configured to be a portable device. In particular, the data storage device 1 can be configured for use with the host device 5 by connecting a cable 28 between respective communication interfaces 3, 37. When not in use, the cable 28 can be disconnected and the data storage device 1 may be moved and transported, and in some examples, used with another host device.

The data storage device 1 is configured with security features to control access to user data stored in the data storage device 1. In some examples, the data storage device is a self-encrypting drive (SED).

### Communication Interface 3 and Communication Channels

The communication interface 3 enables communication between the data storage device 1 and the host device 5. In this example, one function is to provide a wire-based data port between the host device 5 and components of the data storage device 1. In a preferred example, this includes a USB (universal serial bus) bridge 31 to enumerate with the host device 5.

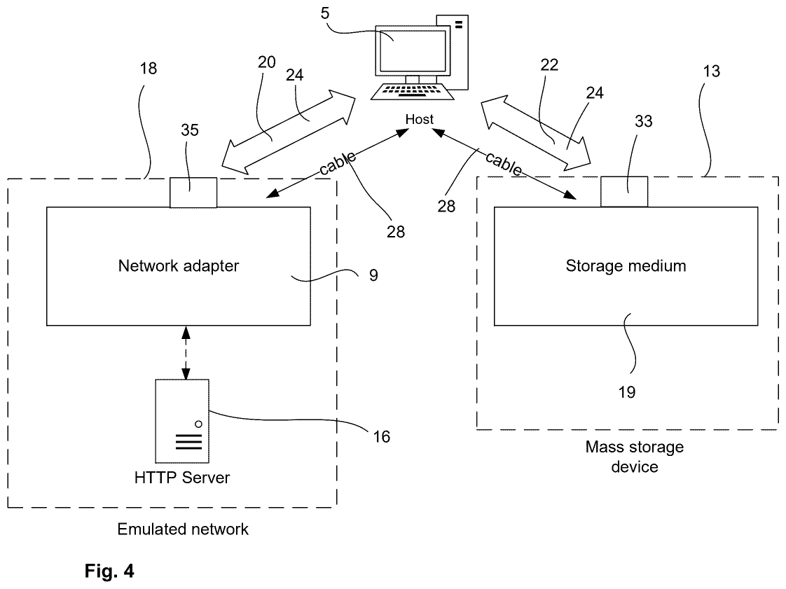

In use, the data storage device 1 can appear, from the perspective of the host device 5, as two different downstream peripheral devices as illustrated in FIG. 4. That is, the communication interface 3 can function as a USB hub. One peripheral device is as a mass data storage device 13, whereby the host uses the storage medium 19 to store, read, and write, user content data. The other peripheral device is where the at least one processor 7 emulates a network adapter 9 and an emulated HTTP server 16 in an emulated network 18.

Thus the first communication channel 20 and second communication channel 22 are respective logical pipes, and data from the two channels may pass through a common physical cable set 28 (such as a USB cable) between the host device 5 and the data storage device 1.

Thus the data storage device 1 is configured to have a first endpoint set 33 to send and receive data transferred through the first communication channel 20 to the network adapter 9. The data sent through the first communication channel can include security commands, or setup/configuration commands, to the data storage device.

Furthermore, a second endpoint set 35 is configured to send and receive data transferred through the second communication channel 22 to the mass storage device 13/ storage medium 19. The second communication channel 22 is used for sending and receiving user data to the storage medium 19 of the data storage device 1 (i.e. the mass storage device 13 function).

### Storage Medium 19

One function of the data storage device 1 is to register with the host device 5 as a mass data storage device providing the functionality to the operating system of the host device 5 of a block data storage device. Data storage device 1 includes a non-transitory storage medium 19 to store user content data. In some examples, this includes unencrypted user content data. In other examples, the storage medium 19 stores encrypted user content data. In some examples, the data storage device is a self-encrypting drive where data is encrypted by a cryptography engine 22 discussed in a separate section below.

The user content data is the data that a user would typically want to store on a data storage device, such as files including image files, documents, video files, etc. The storage medium may be a solid state drive (SSD), hard disk drive (HDD) with a rotating magnetic disk or other non-volatile storage media. Further, the storage medium may be a block data storage device, which means that the user content data is written in blocks to the storage medium 19 and read in blocks from the storage medium 19.

The storage medium 19 includes a secured partition 8 to store user data that is selectively accessible when the data storage device 1 is unlocked. That is, the secured partition 8 is only accessible when authentication data has been verified.

In some examples the storage medium 19 includes only a single secured partition 8 (i.e. the single secured partition 8 exclusively occupies all the storage medium 19). In other examples, the storage medium 19 may be divided into multiple secured partitions 8 that can enable multiple users to have their own respective secured partitions 8 in the same data storage device 1.

In further examples, the storage medium 19 may have a further unsecured partition 10. By unsecured, this means that a host device 5 can read data from the unsecured partition without presenting verified authentication data. In some examples, this is useful for storing data that is freely readable. This can include storing a copy of the web application 17. Thus in some examples, the further unsecured partition 10 may, from the perspective of the host device 5, appear as a mass storage device that is accessible after the cable 28 is connected to the respective communication interfaces 3. This can enable the host device 5 to request a copy of the web application from the unsecured partition 10. Subsequently, the web application is sent from the unsecured partition 10 to the host device 5, via the second communication channel 22. The web application 17 can then run on a browser 12 of the host device 5.

In examples where the web application 17 is stored in the unsecured partition 10, it may be advantageous for the web application 17 to be write protected. This can include specifically write protecting the web application 17. In further examples, this can include write-protecting (or otherwise specifying read-only) for the unsecured partition 10. This can prevent the web application from being inadvertently, or deliberately, deleted or altered. This advantageously enables the web application 17 to be easily available to a host device 5.

In one alternative, the web application 17 is sent 130 to the host device 5 via the first communication channel 20. That is, sent via the emulated network adapter 9. In such examples, the web application 17 may be stored in the storage medium and the at least one processor 7 is configured to send the web application 17 from the storage medium 19 to the host device 5.

### Cryptography Engine

In one example, storage medium 19 comprises a cryptography engine 22 in the form of a dedicated and/or programmable integrated circuit that encrypts data to be stored on storage medium 19 and decrypts data to be read from storage medium 19

The cryptography engine 22 is connected between the communication interface 3/processor 7 and the storage medium 19 and is configured to use a cryptographic key to encrypt 152 user content data into encrypted data to be stored in the secured partition 8 of the storage medium 19. The cryptography engine 22 may also decrypt the encrypted user content data stored in the secured partition 8 of the storage medium 19 into user data to be sent to the host device 5. The cryptography engine 22 may be enabled to perform these functions in response to the at least one processor 7 enabling selective access to the host device 5. The user content data is sent and received to the host device 5, via the cryptography engine 22 and the second communication channel 22.

The at least one processor 7 can function as an access controller and provides, at least in part, the cryptographic key to the cryptography engine 22. For example the at least one processor 7 provide the key to the cryptography engine 22.

The interface between the at least one processor 7 and the communication interface may be an integrated circuit bus which is useful in case this bus is implemented in existing chips. However, it is possible to use many other communication architectures including bus, point-to-point, serial, parallel, memory based and other architectures. The separation of functionality in dedicated chips as illustrated in FIG. 1 is only an example of one implementation. It is possible to combine the functionalities or split the functionalities further. For example, the communication interface may be integrated with the at least one processor 7 into a single chip with a single core. In other cases, the communication interface 3 and the at least one processor 7 can be integrated with the cryptography engine 22 into a single dedicated chip with a single core. In other examples, the chips may have multiple cores.

### Processor

The at least one processor 7 is associated with configuration memory 26 storing software to implement the method described herein. A processor may comprise one or more of microprocessors, microcontrollers, controlling circuitry, or a combination thereof. The one or more processors are, in combination or individually, configured to execute program code stored within the memory 26 to issue commands for controlling the operation of the data storage device 1.

One function of the at least one processor 7 is to emulate a network adapter 9 and server (such as HTTP server 16), to enable authentication data (and other security or configuration commands) to be received via the first communication channel 20. In further examples, this includes additional communication through the first communication channel 20 to the web application 17 instantiated at the browser 12 at the host device 5.

This can include the processor 7 performing additional communication 20 with the host device 5 that is associated with authentication, including authenticating as well as enrolling and configuration for future authentication. Additional communication can also include access control, and other configuration of the data storage device. These will be described in further detail below with reference to example methods.

In some examples, the at least one processor 7 is also involved with access control, including selectively enabling access between the secured partition 8 of the storage medium 19 and the host device 5. In one example, this can include enabling access by sending a cryptographic key to the cryptography engine 22 when authentication and/or authorization requirements are satisfied. This may be responsive to, in some examples, receiving valid authentication data from the host devices through the web application.

In one example, the at least one processor 7 may include a reduced instruction set computer (RISC). In one example, the at least one processor 7 is a Cortex M0 microcontroller from ARM Limited.

### Configuration Memory

Configuration memory 26 stores data related to configuration of the data storage device 1. This may include data related to access control (including authentication data set, cryptographic keys), and other configuration parameters. This may include data related to the web application 17, the HTTP server 16, and the emulated network adapter 9.

Firmware associated with the at least one processor 7 may be stored in the configuration memory 26 or other non-volatile memory. In some examples, the web application 17, or part of the web application, may be stored in the configuration memory 26 (that is separate to the storage medium 19). This may include server-side scripts of the web-application run on the at least one processor 7 to emulate the server 16. In other examples, this may also include client-side scripts that are sent 130 to the host device 5, by the at least one processor 7 via the first communication channel 20.

It is to be appreciated that in some examples, part of the storage medium 19 may be used to store data as the configuration memory.

Authentication data set

The configuration memory may also include an authentication data set. This may include user identifier(s) and respective password(s) of authorized user(s). The authentication data set 65 may include records of authentication data, associated with individuals or groups, which are authorized to interact with the data storage device 1 for additional functions 67.

The authentication data set may be based on data entered during enrolment of user(s). In other examples, the data storage device 1 may be supplied with some authentication data, such as a master password and other authentication data for administrators.

In some examples, the authentication data set 65 is be stored local on the data storage device 1, such as in configuration memory 26. In other examples, at least part of the authentication data set 65 may be stored in the storage medium 19 in encrypted or unencrypted form. This enables authentication by the data storage device 1 without relying on a network or other external systems.

### USB Cable

Communication between the data storage device 1 and the host device 5 can be enabled by a physical connection. In the illustrated example, this includes a cable 28 in accordance with the universal serial bus (USB) standards. This can include USB 2.0, USB 3.0, USB4, etc. In this example, the host device 5 that is connected to the USB bridge 31 would see two USB peripheral devices.

In some examples, the USB cable 28 has ends including one or more of the following connectors:
a. USB-A
b. USB-B
c. Mini-USB B
d. Micro-USB B
e. Micro-USB 3.0
f. USB-C
g. Thunderbolt 1
h. Thunderbolt 2

Referring to FIG. 4, the first device would be the emulated network adapter 9 in communication with the host device 5 through the first communication channel 20, as a logical pipe 24 through the USB cable 28. The second device would be the mass storage device 13 in communication with the host device 5 through the second communication channel 22, as a logical pipe 24 also through the USB cable 28. Thus the one physical USB cable 28 functionally carries both logical communication channels 20, 22. This can be convenient for a user who can make one physical connection to establish both channels.

Host device The host device 5 may include any computing device, electronic device, or electronic computing device that can host a peripheral device and has a web browser 12. Such host devices 5 can include desktop computers, laptop computers, tablet computers, cellular phones, televisions, set top boxes, gaming consoles, electronic books (e-reader), etc.

Referring to FIG. 2, the host device 5 includes a processor 38, a memory 39, and a communication interface 37. The processor 38 may comprise one or more processors that are, in combination or individually, configured to execute program code stored within the memory 26 to issue commands for controlling operation of the host device 5. The communication interface 37 enables the host device 5 to communicate with the data storage device 1 and may further enable the processor 38 to issue commands to the data storage device.

The host device may also include user interfaces, such as a monitor, keyboard, mouse, touchscreen, etc.

The memory 39 of the host device may be configured to include a web browser application 12. Generally, the web browser 12 is configured to open web pages in a network environment. In some examples, this includes communicating in a network environment via hypertext transfer protocol (HTTP).

In addition, the web browser 12 is configured to interact with web applications 17 or run web applications. This can include running scripts in languages such as HTML, CSS, JavaScript. In some examples, the memory 39 of the host device 5 may receive such scripts and web applications from the data storage device 1 that, in turn, are operated in the web browser 17.

The memory 39 may also include drivers 32b, 34b to enable the processor 38 to communicate and operate the emulated network adapter 9 and the mass storage device 13 of the data storage device 1.

### Drivers

Referring to FIG. 1, both the data storage device 1 and the host device 5 include respective device drivers. There are two categories: (i) a USB mass storage driver (34a, 34b) and (ii) Ethernet over USB protocol driver (32a, 32b).

Ideally, the device drivers at the host device 5 side are generic drivers that are provided in the operating system of the host device. This can advantageously enable functionality with the data storage device 1 without having the user to install a bespoke driver to use the data storage device.

USB MASS storage Driver 34a, 34b

The USB mass storage driver 34a, 34b may include a driver compatible with USB mass storage device class (e.g. USB MSC, UMS). These are typically drivers that enable a host device to communicate with a USB device that is an external data storage device (such as an external hard drive, external flash drive, solid state drives, memory cards, etc).

Such USB mass storage drivers are provided natively to operating systems of host devices for ease and efficiency.

The USB mass storage driver 34a, 34b enables communication through the second communication channel 22 to send and receive data via the second endpoint set 35 associated with the mass storage device 13.

Ethernet Over USB Protocol Driver 32a, 32b (e.g. CDC-NCM)

The Ethernet over USB protocol driver 32a, 32b is a driver configured to enable a host device to communicate with an ethernet connection over a USB link.

The USB mass storage driver 34a, 34b enables communication through the first communication channel 20 to send and receive data via the first endpoint set 33 associated with the mass storage device emulated network adapter 9.

Examples of such drivers include NCM (Network Control Model) that is part of CDC (Communication Device Class). Generally, these drivers enable the host device to communicate with other networked devices over HTTP.

The CDC-NCM is a part of the USB class drivers standard that provides a method for network-capable USB devices to manage network traffic. The NCM effectively bridges network data traffic at higher speeds over a USB interface, enabling USB network devices to reach closer to their full speed capabilities. CDC-NCM is implemented as part of the USB standard and it is to be appreciated that in addition to USB revisions (such as USB 2.0, 3.X and USB4), further revisions of USB standards may also utilize CDC-NCM suitable for the presently disclosed method and data storage device.

Advantageously, CDC-NCM is included in many contemporary operating systems of host devices 5.

Compared to other Ethernet over USB drivers, CDC-NCM has efficiency in handling high-speed data transfers and its broad compatibility with various devices and operating systems. CDC NCM provides a balance of performance and reliability for network communication over USB.

It is to be appreciated that other Ethernet over USB drivers and systems could be used, such as RNDIS (Remote Network Driver Interface Specification offered by Microsoft), Ethernet Control Module (ECM), Ethernet Emulation Model (EEM).

### Lightweight IP 36

Referring to FIG. 1, a lightweight IP (lwIP) 36 provides a TCP/IP protocol layer implementation between the Ethernet over USB protocol driver 32a and emulated HTTP server 16.

The lwIP 36 may be a customised layer for the data storage device 1. Advantageously, lwIP is used for memory constrained devices as it provides the networking layer, TCP/IP implementation, and web server to implement a web-application-based interface for authentication and other security commands for the data storage device 1. Since there the USB protocol driver 32a (such as an NCM driver) is below the lwIP 36, it is possible to use customised lwIP 36 without having to use specialised drivers or other software or firmware at the host device 5 to translate the data.

The TCP/IP (Transmission Control Protocol/Internet Protocol) stack is a lower-level layer that underlies HTTP. It ensures data packets are properly routed across networks, provides error-checking and reliability, and handles IP addressing and port management. From the user and host device perspective, when using HTTP 48, this operates over the TCP/IP 49 stack to transmit data between the browser 12 and the web server/HTTP server 16.

### HTTP Server 16

The lwIP 36 can also provide a simple HTTP server 16 to enable the host device 5 to communicate to the data storage device 1 via the web application 17. This includes transmitting and receiving data, via the first communication channel 20, in accordance with Transmission Control Protocol (TCP) or User Datagram Protocol (UDP).

In some examples, the emulated HTTP server 16 may host the web application 17. This may include server-side scripts (like Python, PHP or ASP). In some examples the HTTP server 16 is configured to send the web application 17 to the host device 5 via the first communication channel 20.

### Emulated Network Adapter 9

Referring to FIG. 1, the example emulated network adapter 9 is emulated by a combination of the driver 32a, lwIP 36 and emulated HTTP server 16. It is to be appreciated that alternative computer-implemented methods in software and/or firmware could be used to enable the processor 7 to emulate another example of an emulated network adapter 9.

### Web Application

The web application 17 may be instantiated at a browser 12 of the host device. In some examples, the web application 17 is a client-side script running on the host device 5 (where the host device is a client of the emulated HTTP server 16). In other examples, the web application 17 runs, at least in part, as a server-side script running at the emulated HTTP server where the browser 12 at the host device 5 operates as a terminal. It is to be appreciated in some examples, the web application 17 may be distributed where execution of the program is performed at both the data storage device (hosting the emulated HTTP server 16) and at the host device 5 (with the browser 12).

The use of a web application 17 in a browser 12 increases flexibility and ease of use as many host devices 5 include a browser 12. This can enable host devices 5 using various operating systems to use the data storage device 1 without having to install a proprietary drivers or other applications.

In some examples, the web application 17 comprises, at least in part, hypertext markup language (HTML). This can include HTML5. In other examples, the web application can be based on CSS (Cascading Style Sheets), JavaScript, etc. In other examples, the web application includes server-side scripts (e.g. PHP (Hypertext Preprocessor) or ASP (Active Server Page)). In some examples, Flask (a Python-based web framework) is used to build the server-side web application.

### Method

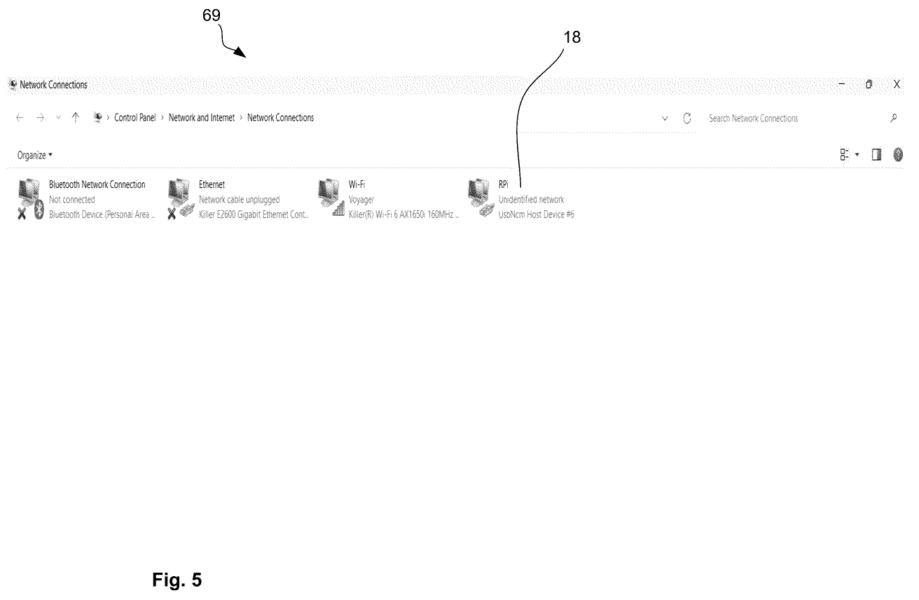

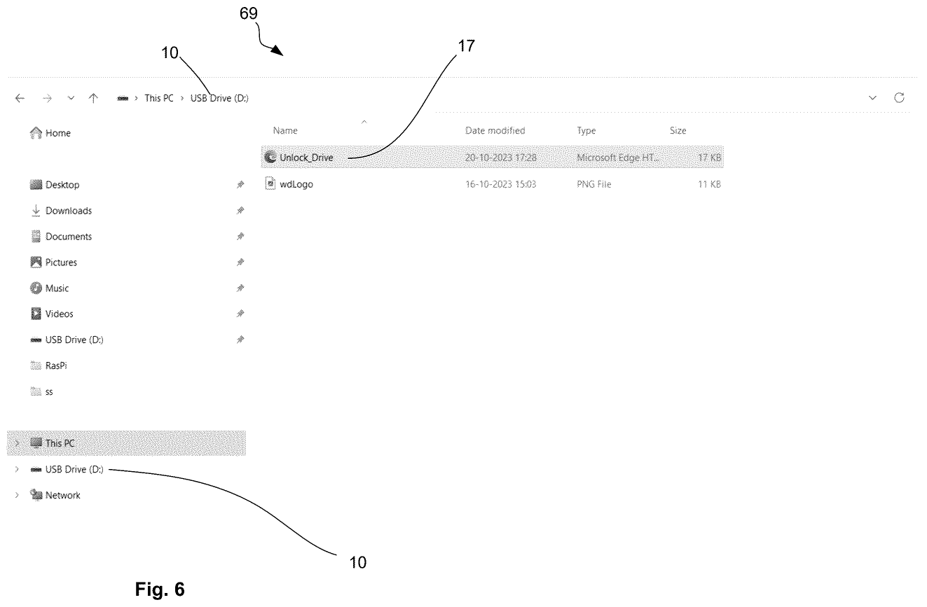

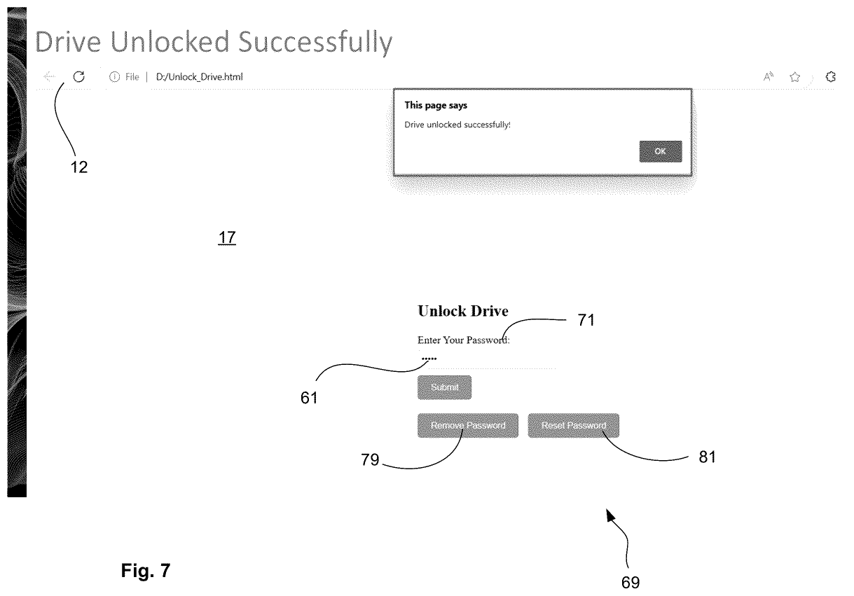

An example of a process of establishing communication with the host device will now be described. FIG. 3 shows a flow diagram of the method 100. FIGS. 5 and 6 illustrate a user interface 69 of the host device 5 during communicative coupling. FIGS. 7 to 11 are representations of the web application 17 in a browser 12 that is shown at a user interface 69 of the host device 5.

### Coupling the Host Device 5 With the Data Storage Device 1

The process includes communicatively coupling the host device 5 with the data storage device 1 and part of this process includes connecting the cable 28 between the respective communication interfaces 3, 37.

The USB (universal serial bus) bridge 31 enumerates with the host device 5 such that there are two peripheral devices, namely a network adapter 9 and a mass storage device 13 as illustrated in FIG. 4.

The network adapter 9 (as an emulated network adapter) is established by communicatively coupling 110 with the host device 5 via the first communication channel 20. This first communication channel 20 is enabled by the Ethernet over USB protocol driver 32a, 32b. FIG. 5 illustrates a user interface 69 showing the connected networks, including the emulated network 18 using the first communication channel 20 and Ethernet over USB protocol driver 32a, 32b.

### First Example—Web Application in Unsecured Partition 10

In some examples, the process includes communicatively coupling with the host device 5 to enable access to an unsecured partition 10 of the storage medium 19 of the data storage device 1. This can include access to the unsecured partition 10 as a mass storage device 13 that can be read by a host device 5 without having to unlock the data storage device 1. This unsecured partition 10 is used to store shared data, such as a copy of the web application 17. In other examples, the unsecured partition 10 may be used to store user instructions, hyperlinks, or other information to assist the user to initialise or otherwise use the data storage device 1 and web application 17.

FIG. 6 illustrates an example of the user interface 69 browsing the unsecured partition 10 of the storage medium and where the unsecured partition 10 stores a copy of the web application 17 (named “Unlock_Drive.html”). The operator may select the web application 17 so that the web application 17 is sent 130′ from the unsecured partition 10 to the host device 5 via the second communication channel 22.

In some examples, the web application 17 is stored in the unsecured partition 10 of the storage medium 19 of the data storage device is read-only and/or write protected. This can prevent deleting or otherwise compromising the web application 17. In further examples, the unsecured partition 10 is read-only.

Thus the web application 17, which in this case is in the form of an HTML script, is opened using a browser application 12 of the host device 5. This can include running the application 17 as a predominately client-side web application.

### Second Example—Web Application Hosted at HTTP Server 16

In another example, the web application 17 is hosted at the emulated HTTP server 16 and the web application 17 is accessed by the browser 12 via the first communication channel 20 and the emulated network adapter 9. This can include entering a URL (uniform resource locator) at the browser 12 to request, or otherwise access, the web application 17.

The emulated HTTP server 16, in response to receiving 125 a request to access the web application 17, sends 130 the web application 17 to the host device 5. This includes sending (at least in part) the web application 17 via the first communication channel 20.

In some examples, the web application 17 may be stored in the storage medium 19. This may include the unsecured partition 10 as noted above, wherein the emulated HTTP server 16 in turn sends the web application 17 to the host device 5. In other examples, the web application 17 is stored in a further memory 26 (such as memory 26) separate to the storage medium 19.

In some examples, the web application 17 is run, at least in part, at the server-side (i.e. at the emulated HTTP server 16). A representation of the web application 17 is, in turn, sent to the host device 5. This enables a user to interact with the web application 17 at the browser 12.

### Other Examples—Web Application Accessed via Other Means

In yet other examples, the web application 17 may be received at the host device 5 via other means. One variation includes downloading the web application 17, via a network, such as the internet. This can include a server (including a cloud server) that has the web application 17 available for download.

In another example, the web application 17 is stored in the memory 39 of the host device 5. This can include a previously downloaded copy of the web application 17 from the internet, or a previously received copy of the web application from the unsecured partition 10.

### Unlocking Drive

FIG. 7 illustrates a representation of an instantiation of the web application 17 at the browser 12. This include a prompt 71 to enable a user to enter authentication data 61, such as a password. In some examples, this can also include a username which can be useful where the data storage device is enabled for multiple users.

The authentication data 61 is then transmitted, via the first communication channel 20, and received 140 at the data storage device 1. The authentication data 61, in some examples, is transmitted in accordance with TCP and/or UDP protocols.

The data storage device 1 verifies 150 that the received authentication data 61 corresponds to a record 63 in an authentication data set 65. This can include comparing the received authentication data to records 63 saved during enrolment of user(s). The authentication data set may be stored in the configuration memory 26.

In response to verifying 150 the authentication data 61 corresponds to a valid record 63 (such as an authorized user), the method 100 includes selectively enabling access 160 between the host device 5 and a secured partition 8 of the storage medium 19 via the second communication channel 22.

In some examples, this includes making the secured partition 8 available part of the mass storage device 13. In alternative examples, this can include enumerating a further mass storage device 13 (such that from the host device perspective there are three peripheral devices being: the emulated network adapter 9, a mass storage device for the unsecured partition 10, and another mass storage device for the secured partition 8).

From the host device 5 perspective, once the data storage device 1 is unlocked such that access is enabled to the secured partition 8 of the storage medium 19, the secured partition 8 can be used as mass storage device 13. In some examples, it is not necessary for further interaction with the browser 12 or web application 17 during the same session to access the secured partition 8. In some examples, the session ends, and the drive is automatically locked again if the cable 28 is disconnected. In other examples, the session ends when the data storage device 1 is locked via the web application 17 (discussed in a separate section below).

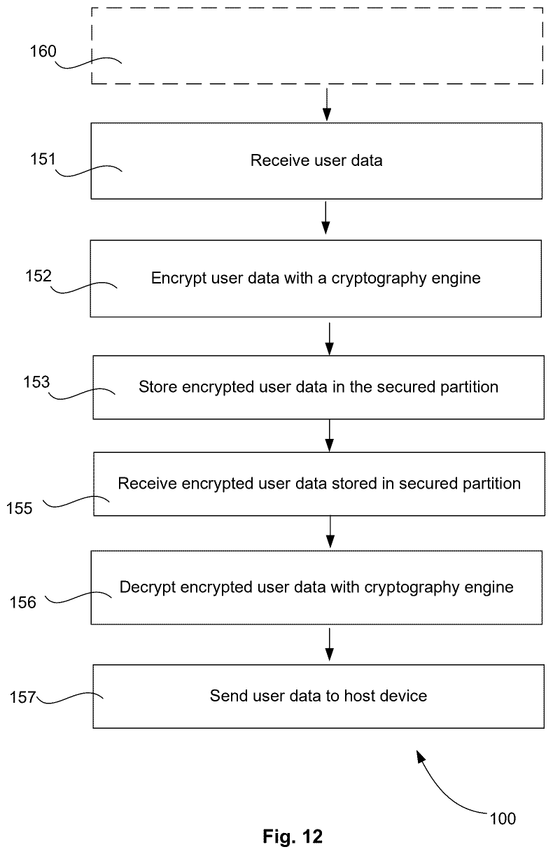

In some examples, enabling access 160 can include enabling access to encrypted user data stored in the secured partition 8. This can have particular application to examples where the data storage device 1 is a self-encrypting drive (SED). This can be enabled by a cryptography engine 23 configured to encrypt and decrypt user data. Referring to FIG. 12, the method 100 may include receiving 151 user data from the host device 5 and, in response encrypting 152 the user data to encrypted data with the cryptography engine 23. The encrypted user data is the stored 153 in the secured partition 8 of the storage medium 19. When the authenticated host device 5 requests the user data, this include receiving 155 encrypted user data stored in the secured partition 8 and, in response decrypting 156 the encrypted user data to user data with the cryptography engine 23. The method 100 further includes sending 157 the user data to the host device 5 via the second communication channel 22.

### Lock Drive

The data storage device 1 may be selectively locked. In some examples, the data storage device 1 may be configured to automatically lock the device when the cable 28 is disconnected to from either the data storage device 1 and/or host device 5. In further examples, the data storage device is configured to lock the device after a specified time of inactivity. For example, if no read/write/erase activity occurs for for 15 minutes, 30 minutes, 1 hour, etc.

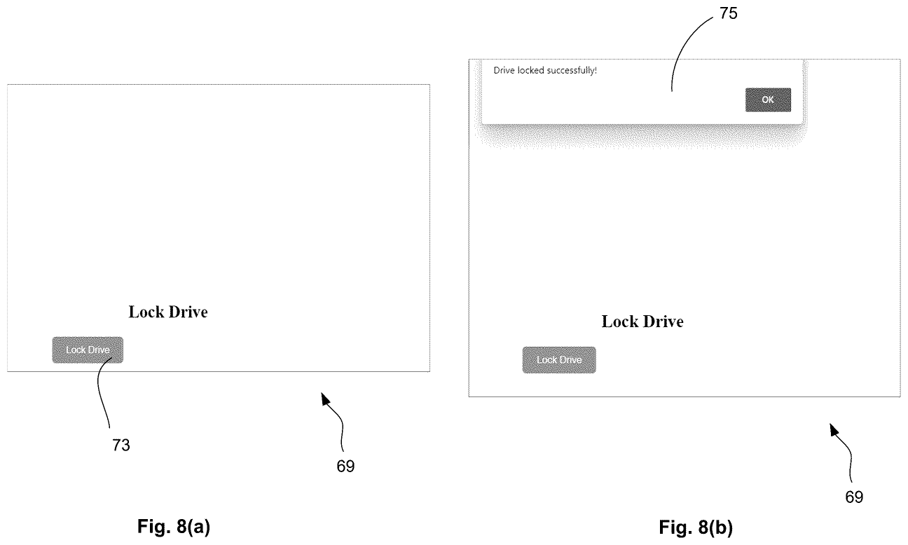

In yet further examples, the web application 17 includes an option for a user to lock secured partition 8. Referring to FIG. 8(a), after a user has unlocked the drive the web application 17 displays a representation with a graphical user interface icon 73 to lock the drive. Upon selecting the icon 73, this sends a lock command via the first communication channel 20 to the data storage device 1. In response, the data storage device 1 disables access between the host device 5 and the secured partition 8 of the storage medium.

In some examples, a confirmation message 75 is sent, via the first communication channel 20, to the host device that is displayed in the web application 17 as illustrated in FIG. 8(b).

### Initialization and Setting Password

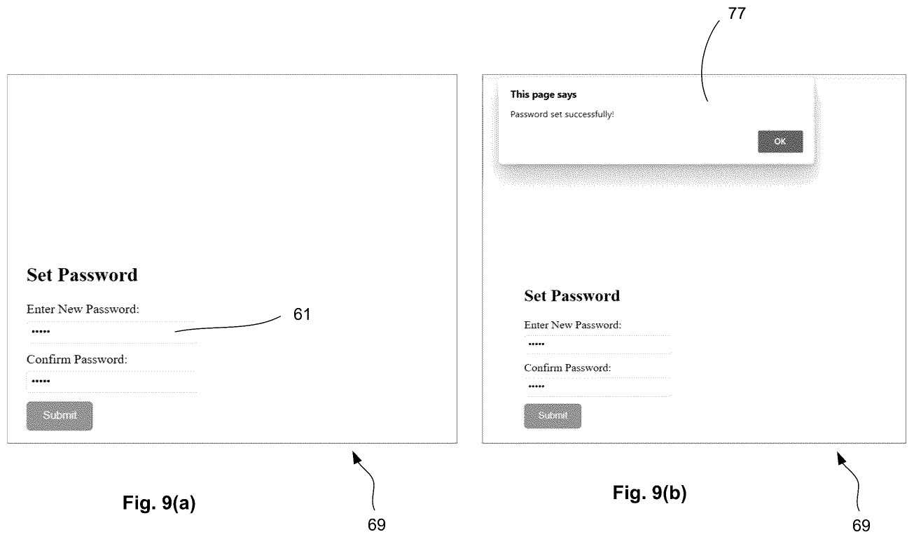

FIG. 9(a) illustrates an example of enrolling a user and their corresponding password as authentication data. This includes a prompt for a user to enter their desired password 61 in the web application 17. Although this example only includes a password, it is to be appreciated that a user identifier in conjunction with a password can form the authentication data 61. The desired authentication data 61 is then sent from the host device 5 to the data storage device 1, wherein the processing device 7 stores the authentication data 61 as part of the authentication data set 65. In some examples the processor 7, or the instantiated web application 17, may check the desired authentication data before storing it. This may include checking that the authentication data 61 is properly formed and meets requirements such as minimum length and/or complexity.

Upon successful enrolment of the authentication data, a notification 77 may be sent from the data storage device 1 to be displayed at web application 17 in the browser as shown in FIG. 9(b).

In some examples, multiple passwords (e.g. multiple records in the authentication data set) can be stored in the data storage device 1 to enable multiple users to have access to the secured partition 8.

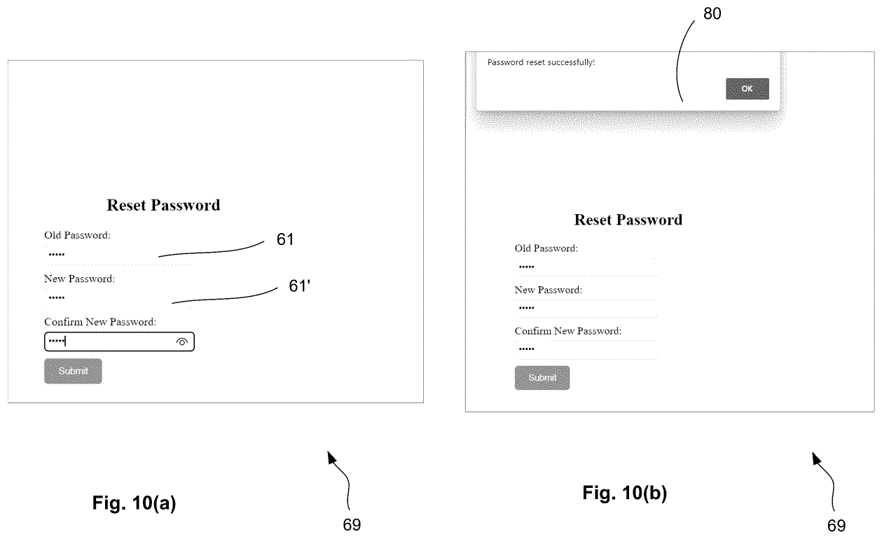

In further examples, a password 61 may be removed 79 or reset 81. FIG. 7 illustrates these selectable options during unlocking of the data storage device 1. FIG. 10(a) illustrates an example of the web application 17 providing an interface for a user to enter their existing password 61 and reset it with a new password 61′ as authentication data. The authentication data 61, 61′ is then sent to the data storage device 1 and upon verifying the existing password 61, the new password 61′ can be stored as part of the authentication data set. A notification 80 of successful reset is sent to a representation of the web application 17 in the browser 12 as shown in FIG. 10(b).

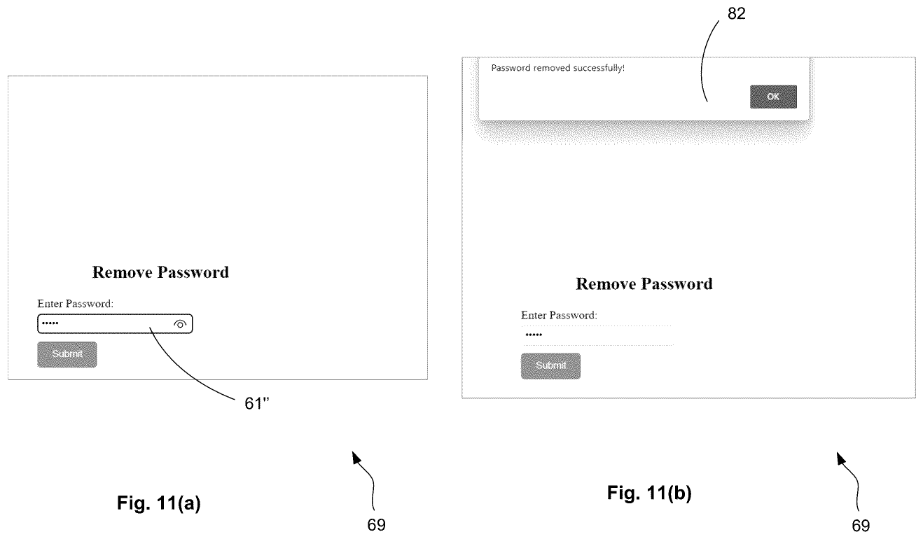

FIG. 11(a) illustrates an example of the web application 17 providing an interface for removing 79 a password 61″. This may be useful in cases where there are multiple passwords for multiple enrolled users, and it is desirable to remove one of the passwords if one of the users should no longer have access to the secured partition 8. The authentication data 62″ to be removed is then sent to the data storage device 1 and upon successful removal of the respective record 63 from the authentication data set 65, a notification 82 is sent to a representation of the web application 17 in the browser as shown in FIG. 11(b).

The above described commands are security commands and these are sent and received between the data storage device 1 and the host device 5 via the first channel 20. This can include securely sending these security commands over HTTP and enabled by the TCP and UDP protocols at the lwIP.

### Advantages

The present disclosure includes using a web-based interface accessed through a web browser to manage a data storage device, such as a USB drive. Users can perform actions like locking and unlocking the data storage device's content stored in the storage medium securely through this interface.

Examples of the presently described data storage device 1 and method 100 can offer cross-platform compatibility. Instead of requiring operating system specific applications (e.g. an application for each of Windows, MacOS, and other operating systems) and drivers, the web-based interface can be accessed from any platform (host device) with a web browser.

In addition, there is reduced complexity. By removing operating system specific applications can streamline USB drive management for both end-users and information technology administrators. This includes reducing or removing the requirement to maintain different software versions or worry about compatibility issues with different operating systems.

In some examples, this described data storage device and method enhances security. This can include leveraging browser security features such as sandboxing and HTTPS (HTTP Secure) to provide a secure environment for USB drive management and protecting data from unauthorized access and threats.

In some examples, the method and data storage device users CDC NCM drivers for sending security commands between data storage device and the host device. Advantageously, the CDC NCM driver is supported by major operating systems and by a wide range of USB host devices. This assists in compatibility with a wide range of hardware and software.

### Variations

In the example illustrated in FIGS. 1 and 2, the first communication channel 20 and the second communication channel 22 are carried through a shared physical cable 28. It is to be appreciated that in one alternative, the first communication channel 20 is carried via a cable 28. However, the second communication channel 22 is via an alternative means, such as via Wi-Fi. That is, the mass storage driver 34b is configured to send and receive user data via a wireless Wi-Fi network.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A data storage device comprising:
a storage medium with at least a secured partition configured to store user data;
a communication interface configured to communicate with a host device; and
at least one processor configured, individually or in combination, to:
communicatively couple with the host device, via a first communication channel, wherein the at least one processor is configured to emulate a network adapter to the host device, wherein the first communication channel is enabled by an Ethernet over USB (Universal Serial Bus) protocol driver;
communicatively couple with the host device, via a second communication channel, wherein the second communication channel enables communication between the storage medium and the host device, and wherein the second communication channel is enabled by a USB mass storage driver;
receive, via the first communication channel, authentication data from the host device, wherein the authentication data is received from a web application instantiated at a browser of the host device;
verify that the received authentication data corresponds to a record in an authentication data set; and
in response to verifying the received authentication data, selectively enable access between the host device and the secured partition via the second communication channel.

2. A data storage device according to claim 1, wherein the Ethernet over USB protocol driver is CDC-NCM (Communication Device Class Network Control Model).

3. A data storage device according to claim 1, wherein the storage medium or a further memory is configured to store the web application, and wherein the at least one processor is further configured to:
send to the host device, via the first communication channel, the web application or a representation of the web application.

4. A data storage device according to claim 3, wherein the at least one processor is further configured to emulate a server, wherein the server is configured to host the web application.

5. A data storage device according to claim 1, wherein the storage medium further comprises an unsecured partition configured to store the web application, and wherein the data storage device is configured send the web application from the unsecured partition to the host device via the second communication channel.

6. A data storage device according to claim 5, wherein the web application stored in the unsecured partition is read-only and/or write protected.

7. A data storage device according to claim 1, wherein the communication interface includes a USB bridge, and wherein the first communication channel and the second communication channel are respective logical pipes through a USB cable between the host device and the data storage device.

8. A data storage device according to claim 7, further comprising:
a first endpoint set to send and receive data transferred through the first communication channel; and
a second endpoint set to send and receive data transferred through the second communication channel.

9. A data storage device according to claim 1 further comprising:
a cryptography engine, wherein in response to selective access between the host device and the secured partition, the cryptography engine is configured to:
encrypt user data to encrypted data and in response, send the encrypted data to be stored in the secured partition; and
decrypt encrypted data stored in the secured partition to user data,
wherein the communication interface is configured to receive and send user data between the data storage device and the host device, via the second communication channel.

10. A data storage device according to claim 1, wherein the web application comprises at least one or more of:
Hypertext Markup Language (HTML);
Cascading Style Sheets; and
JavaScript.

11. A data storage device according to claim 1, wherein the communication interface is configured to transmit and receive data, via the first communication channel, in accordance with Transmission Control Protocol (TCP) and/or User Datagram Protocol (UDP).

12. A method for a data storage device to communicate with a host device, the method comprising:
communicatively coupling with the host device via a first communication channel, wherein the data storage device emulates a network adapter to the host device, wherein the first communication channel is enabled by an Ethernet over USB (Universal Serial Bus) protocol driver;
communicatively coupling with the host device via the second communication channel, wherein the second communication channel enables communication between a storage medium of the data storage device and the host device, and wherein the second communication channel is enabled by a USB mass storage driver;
receiving, via the first communication channel, authentication data entered into, or via, a web application instantiated at a browser of the host device,
verifying that the received authentication data corresponds to a record in an authentication data set; and
in response to verifying the received authentication data, selectively enabling access between the host device and a secured partition of the storage medium of the data storage device, via the second communication channel.

13. A method according to claim 12, wherein the Ethernet over USB protocol driver uses CDC-NCM (Communication Device Class Network Control Model).

14. A method according to claim 12, wherein in response to receiving a request to access the web application, the method further comprises:
sending to the host device, via the first communication channel, the web application or a representation of the web application.

15. A method according to claim 12 wherein communicatively coupling with the host device enables access to an unsecured partition of the storage medium of the data storage device, wherein the unsecured partition is configured to store the web application; and the method further comprises:
sending the web application from the unsecured partition to the host device, via the second communication channel.

16. A method according to claim 12, wherein the first communication channel and the second communication channel are respective logical pipes through a USB cable between the host device and the data storage device.

17. A method according to claim 12, wherein the secured partition of the storage medium is configured to store encrypted user data, and wherein the method further includes:
receiving user data from the host device via the second communication channel and, in response,
encrypting, with a cryptography engine, user data to encrypted data; and
storing the encrypted user data in the secured partition of the storage medium;
receiving encrypted user data stored in the secured partition of the storage medium and, in response;
decrypting, with the cryptography engine, encrypted user data to user data; and
sending user data to the host device via the second communication channel.

18. A method according to claim 12, wherein the web application comprises at least one or more of:
Hypertext Markup Language (HTML);
Cascading Style Sheets; and
JavaScript.

19. A method according to claim 12, wherein data transmitted via the first communication channel is transmitted in accordance with Transmission Control Protocol (TCP) and/or User Datagram Protocol (UDP).

20. A data storage device comprising:
means for storing data and means for selectively enabling access between the means for storing data and a host device;
means for communicatively coupling with the host device via a first communication channel, wherein the data storage device further comprises means for emulating a network adapter to the host device, wherein the first communication channel is enabled by an Ethernet over USB (Universal Serial Bus) protocol driver;
means for communicatively coupling with the host device via the second communication channel, wherein the second communication channel enables communication between the means for storing and the host device, and wherein the second communication channel is enabled by a USB mass storage driver;
means for receiving, via the first communication channel, authentication data entered into, or via, a web application instantiated at a browser of the host device,
means for verifying that the received authentication data corresponds to a record in an authentication data set; and
in response to verifying the received authentication data, the means for selectively enabling access is configured to enable access between the host device and the means for storing data, via the second communication channel.
